(19) United States
(12) Patent Application Publication
(10) Pub. No.: US 2022/0022219 A1
(43) Pub. Date: Jan. 20, 2022

(54) METHOD AND APPARATUS FOR SCHEDULING UPLINK TRANSMISSION

(71) Applicant: Telefonaktiebolaget LM Ericsson (publ), Stockholm (SE)

(72) Inventors: Jinhua Liu, Beijing (CN); Min Wang, Luleå (SE)

(21) Appl. No.: 17/292,483

(22) PCT Filed: Oct. 29, 2019
(86) PCT No.: PCT/CN2019/114023

§ 371 Date: May 10, 2021

(30) Foreign Application Priority Data
Nov. 9, 2018 (CN) PCT/CN2018/114867

(51) Int. Cl. H04W 72/12

(52) U.S. Cl. CPC H04W 72/1268; H04W 72/1278

(57) ABSTRACT

Various embodiments of the present disclosure provide a method for scheduling uplink transmission. The method which may be performed in a terminal device comprises receiving configuration information indicating first and second resource allocations from a network node. In an exemplary embodiment, the first resource allocation, compared with the second resource allocation, may assign more frequent occasions to the terminal device to transmit a scheduling request for uplink data. The method further comprises determining, based at least in part on the configuration information, which of the first and second resource allocations is to be activated for the transmission of the scheduling request. According to some embodiments of the present disclosure, the uplink transmission can be scheduled adaptively and flexibly, so that network throughput and resource efficiency can be improved.

### FIELD OF THE INVENTION

The present disclosure generally relates to communication networks, and more specifically, to scheduling data transmission in a communication network.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the rapid development of networking and communication technologies, wireless communication networks such as long-term evolution (LTE) and new radio (NR) networks are expected to achieve high traffic capacity and end-user data rate. In order to meet data transmission requirements, terminal devices can send scheduling requests (SRs) to the wireless communication networks to request radio resource for data transmission. Scheduling configuration of data transmission may affect quality of service and utilization of radio resource. Thus, it is desirable to improve the scheduling configuration of data transmission efficiently.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In a wireless communication network such as LTE and NR, the scheduling of uplink (UL) data transmission is usually controlled by a network node such as a base station (BS). A terminal device such as user equipment (UE) can transmit UL data, for example, by sending a SR to the network node and using radio resource configured for UL data transmission by the network node. However, less SR transmission occasions for the UE may introduce additional latency to UL scheduling and limit the downlink (DL) throughput. On the other hand, configuring more SR transmission occasions for the UE may increase resource overhead and even degrade resource utilization. Therefore, it may be desirable to improve configuration of data transmission scheduling in a more efficient way.

Various embodiments of the present disclosure propose a solution of scheduling data transmission in a communication network, which can enable a terminal device to switch between different configurations or patterns of radio resources available for SR transmission, so that the terminal device can perform data transmissions with lower latency and higher rate.

According to a first aspect of the present disclosure, there is provided a method performed by a terminal device. The method comprises receiving configuration information indicating first and second resource allocations from a network node. In an exemplary embodiment, the first resource allocation, compared with the second resource allocation, may assign more frequent occasions to the terminal device to transmit a SR for UL data. The method further comprises determining, based at least in part on the configuration information, which of the first and second resource allocations is to be activated for the transmission of the SR.

In accordance with an exemplary embodiment, the method according to the first aspect of the present disclosure may further comprise: receiving an indicator from the network node to indicate the terminal device to perform at least one of: activating one of the first and second resource allocations, and inactivating at least one of the first and second resource allocations.

In accordance with an exemplary embodiment, the method according to the first aspect of the present disclosure may further comprise: transmitting a response to the indicator to the network node, in response to the reception of the indicator.

In accordance with an exemplary embodiment, the method according to the first aspect of the present disclosure may further comprise: reporting to the network node at least one of: activation of one of the first and second resource allocations, and inactivation at least one of the first and second resource allocations.

According to a second aspect of the present disclosure, there is provided an apparatus which may be implemented as a terminal device. The apparatus may comprise one or more processors and one or more memories comprising computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus such as a terminal device. The apparatus may comprise a receiving unit and a determining unit. In accordance with some exemplary embodiments, the receiving unit may be operable to carry out at least the receiving step of the method according to the first aspect of the present disclosure. The determining unit may be operable to carry out at least the determining step of the method according to the first aspect of the present disclosure.

According to a fifth aspect of the present disclosure, there is provided a method performed by a network node. The method comprises determining configuration information indicating first and second resource allocations for a terminal device. In an exemplary embodiment, the first resource allocation, compared with the second resource allocation, may assign more frequent occasions to the terminal device to transmit a SR for UL data. The method further comprises transmitting the configuration information to the terminal device for determination, by the terminal device, of which of the first and second resource allocations is to be activated for the transmission of the SR.

In accordance with an exemplary embodiment, the determination of the configuration information by the network node may be based at least in part on a radio condition of the terminal device.

In accordance with an exemplary embodiment, the method according to the fifth aspect of the present disclosure may further comprise transmitting an indicator to the terminal device to indicate the terminal device to perform at least one of: activating one of the first and second resource allocations, and inactivating at least one of the first and second resource allocations.

In accordance with an exemplary embodiment, the indicator may be determined by the network node according to at least one of: a radio condition of the terminal device; a traffic load of the network node; a DL data transmission situation of the terminal device; an inactivity period of the terminal device; a congestion control strategy applied to the terminal device; and a status of a predefined timer.

In accordance with an exemplary embodiment, the method according to the fifth aspect of the present disclosure may further comprise: receiving a response to the indicator from the terminal device.

In accordance with an exemplary embodiment, the method according to the fifth aspect of the present disclosure may further comprise receiving from the terminal device a report of at least one of: activation one of the first and second resource allocations, and inactivation at least one of the first and second resource allocations.

According to a sixth aspect of the present disclosure, there is provided an apparatus which may be implemented as a network node. The apparatus may comprise one or more processors and one or more memories comprising computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus such as a network node. The apparatus may comprise a determining unit and a transmitting unit. In accordance with some exemplary embodiments, the determining unit may be operable to carry out at least the determining step of the method according to the fifth aspect of the present disclosure. The transmitting unit may be operable to carry out at least the transmitting step of the method according to the fifth aspect of the present disclosure.

In accordance with an exemplary embodiment, the determination of which of the first and second resource allocations is to be activated for the transmission of the SR based at least in part on the configuration information may comprise: determining to activate the first resource allocation during a first time period for which, compared with a second time period, more frequent occasions are needed by the terminal device to request scheduling of the UL data.

In accordance with an exemplary embodiment, the determination of which of the first and second resource allocations is to be activated for the transmission of the SR based at least in part on the configuration information may comprise: determining to activate the second resource allocation during a second time period for which, compared with a first time period, less frequent occasions are needed by the terminal device to request scheduling of the UL data.

In accordance with an exemplary embodiment, the first resource allocation may be inactivated when the second resource allocation is activated, and the second resource allocation may be inactivated when the first resource allocation is activated.

In accordance with an exemplary embodiment, the UL data may comprise data of a transmission control protocol (TCP) service.

In accordance with an exemplary embodiment, the terminal device during the first time period may be in a slow-start phase for the TCP service, and the terminal device during the second time period may be not in the slow-start phase.

In accordance with an exemplary embodiment, the slow-start phase may be indicated by a predefined timer. Optionally, the predefined timer may be set based at least in part on one or more performance parameters of the terminal device.

In accordance with an exemplary embodiment, during the first time period, a DL connection between the terminal device and the network node may be configured with a first congestion window below a first threshold. Alternatively or additionally, during the second time period, the DL connection of the terminal device may be configured with a second congestion window above a second threshold. The first threshold and the second threshold may be the same or different.

According to a ninth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the fifth aspect of the present disclosure.

According to a tenth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the fifth aspect of the present disclosure.

According to an eleventh aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first aspect of the present disclosure.

According to a twelfth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first aspect of the present disclosure.

According to a thirteenth aspect of the present disclosure, there is provided a method implemented in a communication system which may include a host computer, a base station and a UE. The method may comprise, at the host computer, receiving user data transmitted to the base station from the UE which may perform any step of the method according to the first aspect of the present disclosure.

According to a fourteenth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first aspect of the present disclosure.

According to a fifteenth aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the fifth aspect of the present disclosure.

According to a sixteenth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the fifth aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating an example of UL scheduling and transmission according to some embodiments of the present disclosure;

FIG. 2 is a diagram illustrating an example of adaptive SR transmission according to some embodiments of the present disclosure;

FIG. 3 is a diagram illustrating an example of performance gain according to some embodiments of the present disclosure;

FIG. 4 is a flowchart illustrating a method according to some embodiments of the present disclosure;

FIG. 5 is a flowchart illustrating another method according to some embodiments of the present disclosure e;

FIG. 6 is a block diagram illustrating an apparatus according to some embodiments of the present disclosure;

FIG. 7 is a block diagram illustrating another apparatus according to some embodiments of the present disclosure;

FIG. 8 is a block diagram illustrating yet another apparatus according to some embodiments of the present disclosure;

FIG. 9 is a block diagram illustrating a telecommunication network connected via an intermediate network to a host computer in accordance with some embodiments of the present disclosure;

FIG. 10 is a block diagram illustrating a host computer communicating via a base station with a UE over a partially wireless connection in accordance with some embodiments of the present disclosure;

FIG. 11 is a flowchart illustrating a method implemented in a communication system, in accordance with an embodiment of the present disclosure;

FIG. 12 is a flowchart illustrating a method implemented in a communication system, in accordance with an embodiment of the present disclosure;

FIG. 13 is a flowchart illustrating a method implemented in a communication system, in accordance with an embodiment of the present disclosure; and

FIG. 14 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Wireless communication networks are widely deployed to provide various telecommunication services such as voice, video, data, messaging and broadcasts. To meet dramatically increasing network requirements on traffic capacity and data rates, one interesting option for communication technique development is to allow a wireless communication network such as LTE or NR to configure more flexible and adaptive scheduling of data transmissions.

A terminal device such as UE can use a SR to request uplink shared channel (UL-SCH) resources for new data transmission. The medium access control (MAC) entity may be configured with zero, one, or more SR configurations. An SR configuration may consist of a set of physical uplink control channel (PUCCH) resources for SR transmission across different bandwidth parts (BWPs) and cells. For a logical channel, at most one PUCCH resource for SR is configured per BWP. Each SR configuration corresponds to one or more logical channels. Each logical channel (LCH) may be mapped to zero or one SR configuration, which is configured by radio resource control (RRC). The SR configuration of the LCH that triggers a buffer status report (BSR) (if such a configuration exists) is considered as corresponding SR configuration for the triggered SR. For BSR triggered by retxBSR-Timer expiry, the corresponding SR configuration for the triggered SR is that of the highest priority LCH (if such a configuration exists) that has data available for transmission at the time the BSR is triggered.

In accordance with some exemplary embodiments, an SR may be triggered for a UE when this UE has triggered a regular BSR and one of the below conditions is satisfied:
if there is no UL-SCH resource available for a new transmission; or
if the MAC entity is configured with UL grant(s) and the regular BSR was not triggered for a logical channel for which logical channel SR masking (logicalChannelSR-Mask) is setup by upper layers; or
if the UL-SCH resources available for a new transmission do not meet the link control protocol (LCP) mapping restrictions configured for the logical channel(s) that triggered the BSR(s).

When an SR is triggered, this SR is considered as pending until it is cancelled. All pending SR(s) need to be cancelled and each respective sr-ProhibitTimer will be stopped when a MAC packet data unit (PDU) is assembled and this PDU includes a BSR which contains buffer status up to (and including) the last event that triggered a BSR, or when the UL grant(s) or resources can accommodate all pending data available for transmission. Only PUCCH resources on a BWP which is active at the time of SR transmission occasion are considered valid.

For a pending SR, if the MAC entity has no valid PUCCH resource configured for the pending SR, a random access procedure may be initiated on the special cell (SpCell) and the pending SR is canceled. Otherwise, for the SR configuration corresponding to the pending SR, when the MAC entity has an SR transmission occasion on the valid PUCCH resource for SR configured and the condition for SR transmission is satisfied, the MAC entity can instruct the physical layer to signal the SR on the valid PUCCH resource for SR and start the sr-ProhibitTimer.

There may be two PUCCH formats (i.e., short and long PUCCH formats) applicable in NR. The short PUCCH format comprises 1-2 symbols. However, if more time resources are available, the long PUCCH format can have a duration of 4 to 14 symbols. The two PUCCH formats can be applied for LCHs with different latency requirements respectively. For example, the short PUCCH format may be of high relevance for ultra-reliable low latency communication (URLLC) like services.

In accordance with some exemplary embodiments, the SR on a PUCCH (which is also referred to as PUCCH-SR hereinafter) is repeatedly transmitted on consecutive SR opportunities on the PUCCH until the UE receives an UL grant on physical downlink control channel (PDCCH). The SR transmission on the PUCCH is stopped at least when PUCCH resources are released and/or UL synchronization is lost even if the UE has not received any UL grant on PDCCH. After stopping transmission on the PUCCH-SR, the UE initiates transmission on the random access channel (RACH). In this case, the UE already has a valid cell-radio network temporary identifier (C-RNTI) and can include C-RNTI in message 3 for contention resolution purpose.

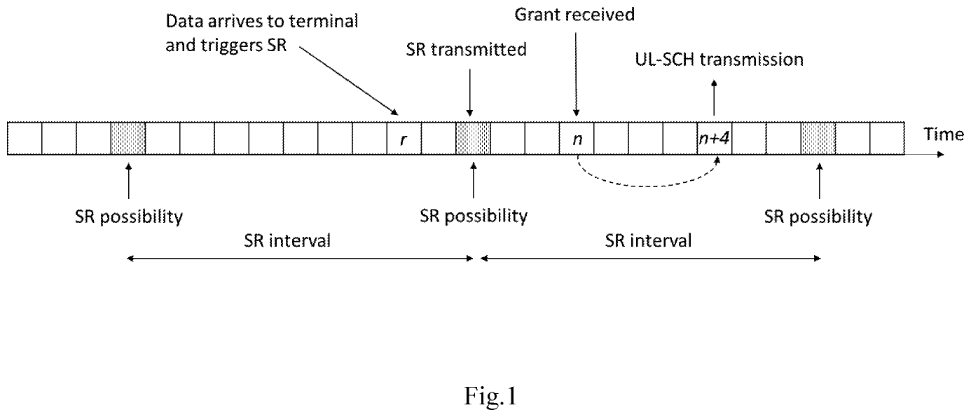

FIG. 1 is a diagram illustrating an example of UL scheduling and transmission according to some embodiments of the present disclosure. The example shown in FIG. 1 may be applicable to an LTE scenario where an eNB can control the scheduling of UL data transmissions from terminal devices such as UEs. It will be appreciated that there may be other scenarios where the communication network may apply or support various radio interface technologies which are not limited to LTE technology. For example, the scheduling procedure as shown in FIG. 1 may also be applicable to NR systems.

In the example shown in FIG. 1, a scheduler at the eNB needs knowledge about the amount of data awaiting transmission from the UEs so as to assign the proper amount of UL resources. Obviously, there is no need to provide UL resource to a UE without data to transmit as this may only result in that the UE performs padding to fill up the granted resource. Hence, as a minimum, the scheduler needs to know whether the UE has data to transmit and requests an UL grant. According to some exemplary embodiments, the UL grant may comprise some scheduling configurations for the UE, for example, resource allocation, transmission parameters such as a rank indicator (RI) or a precoding matrix indicator (PMI), etc. Correspondingly, the UE may transmit UL data according to the UL grant received from a BS. The knowledge about the UL data transmission of the UE may be informed to the eNB by a SR and a buffer status report (BSR) from the UE. The SR may be a simple flag, raised by the UE to request UL resource from the scheduler at the eNB.

Since the UE requesting the UL resource by definition has no physical uplink shared channel (PUSCH) resource, the SR may be transmitted on the PUCCH. The UE can be assigned a dedicated PUCCH resource for transmitting the SR. There may be one transmission opportunity/occasion (which is indicated by “SR possibility” in FIG. 1) every mth subframe. When UL data arrives (e.g., at subframe r), the UE can trigger transmission of the SR. Upon the reception of the SR from the UE, the scheduler at the eNB can assign a grant to the UE. If the UE does not receive a grant for scheduling UL data transmission until the next possible transmission opportunity/occasion for the SR, then the SR may be repeated. If the UE receives a grant from the eNB (e.g., at subframe n), it can transmit the UL data in the granted resource (e.g., at subframe n+4). Besides, the current BSR may also be transmitted by the UE in the UL-SCH transmission carrying the UL data to request more UL grants. Then the eNB can know how many radio resources need to be scheduled for the UE.

For a wireless communication network, file transfer protocol (FTP) downloading/Web surf may be a dominant traffic in the network. In most of the time, a UE may have multiple best effort (BE) services on-going at the same time. FTP downloading as one typical BE service together with other BE services are mapped to a default radio bearer (RB), also named as BE RB, since those BE services are not delay-sensitive and it is sufficient to deploy one RB for one UE.

The FTP downloading/Web surf is a DL heavy service, meaning that the UE may then have a large volume of data transmission in the DL, while there is only light UL traffic to carry the radio link control/transmission control protocol acknowledgement (RLC/TCP ACK). To avoid congestion collapse, TCP uses a multi-faceted congestion control strategy. For each connection, TCP maintains a congestion window (CWND), limiting the total number of unacknowledged packets that may be in transit end-to-end. TCP uses a mechanism called slow-start to increase the CWND after a connection is initialized or after a timeout. The CWND in the slow-start phase starts with a window of a small multiple of the maximum segment size (MSS) in size. For example, the slow-start phase may begin initially with the CWND of 1, 2, 4 or 10 MSS. For every packet acknowledged, the CWND increases by one MSS so that the CWND effectively doubles for every round-trip time (RTT). When the CWND exceeds the slow-start threshold, the congestion control strategy enters the congestion avoidance phase in which as long as non-duplicate ACKs are received, the CWND is additively increased by one MSS every RTT.

For the BE RB, especially the light UL traffic case, it is typically configured with one PUCCH-SR configuration associated with infrequent PUCCH-SR transmission occasions, since the PUCCH-SR configuration is suitable for BE services on the BE RB. In such scenario, there is a problem that the infrequent transmission occasions of PUCCH-SR may introduce additional latency to UL scheduling which is used to get a small UL grant to transmit the TCP ACK. This latency inevitably limits the DL throughput, and also degrades DL system resource utilization. The issue is also relevant to FTP uploading. In this case, the seldom PUCCH-SR transmission may bring additional latency to the TCP RTT which incurs a slow increase of TCP CWND and limits the UL throughput.

A possible way to improve the performance is to increase transmission occasion density for PUCCH-SR. However, assignment of dense SR occasions means a large resource overhead for PUCCH-SR. Therefore, it is very meaningful to study possible enhancement on UL scheduling to improve the DL throughput for data services such as FTP downloading/Web surf, while at the same time not negatively impact other services with more critical quality of service (QoS) requirements.

In order to enhance the scheduling of UL data transmission (e.g., for the TCP ACK traffic) and improve the latency performance of network services, the present disclosure according to some exemplary embodiments proposes to enable the radio resource configuration(s) of SR transmission for UL data to be adaptive to UL traffic characteristics. For example, the PUCCH-SR configuration or resource allocation associated with the BE RB can be set to fit with TCP slow-start characteristics. The adaptive resource allocation for PUCCH-SR can also enhance the slow-start of the UL traffic.

According to the proposed solution, a UE may be assigned with one SR configuration comprising adaptive PUCCH-SR resource patterns, without pre-configuration of more frequent PUCCH-SR resources to the TCP ACK traffic of DL FTP downloading services. The configured PUCCH-SR resource patterns may comprise a dense resource pattern in which the configured resources can provide dense PUCCH-SR occasions, and a sparse resource pattern in which the configured resources can provide sparse PUCCH-SR occasions. In accordance with some exemplary embodiments, during the slow-start phase of a TCP service, dense PUCCH-SR occasions are provided and the delay to get a UL grant for TCP ACK can be reduced. After the TCP slow-start phase, sparse PUCCH-SR occasions for TCP ACK are provided to reduce the consumption of PUCCH-SR resources. Optionally, the slow-start phase can be determined based at least in part on a timer, the achievable data rate or inactivity period of a UE, and etc.

Alternatively, a UE may be assigned with two SR configurations associated with the same TCP service. One of the SR configurations is a dense resource configuration that can provide more frequent PUCCH-SR occasions, and the other is a sparse resource configuration that can provide less frequent PUCCH-SR occasions. The UE can switch between the two SR configurations for UL scheduling (e.g., for TCP ACK), depending on whether the TCP service of the UE is in the slow-start phase. It can be appreciated that although some embodiments are described with respect to the DL-TCP traffic scenarios where the TCP ACK is transmitted in the UL from the UE to the network, the proposed solution is also applicable for other UL traffics.

It is noted that some embodiments of the present disclosure are mainly described in relation to LTE or NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

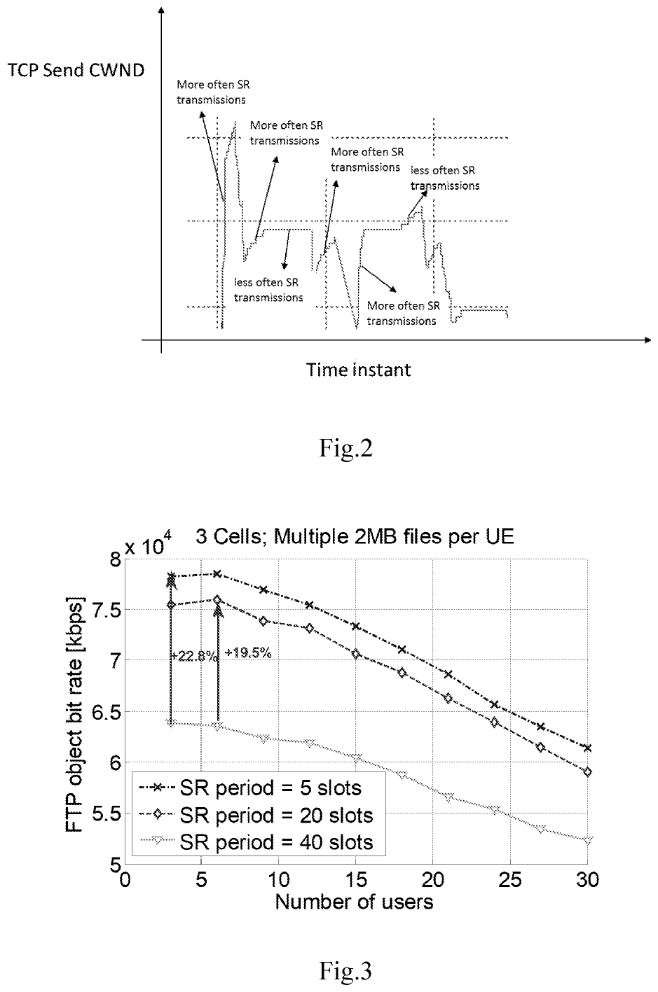

FIG. 2 is a diagram illustrating an example of adaptive SR transmission according to some embodiments of the present disclosure. In this example, SR transmission occasions are adaptive to the variation of the TCP send CWND (also known as TCP CWND). As shown in FIG. 2, when the TCP CWND applied for a UE is low (e.g., the TCP service is in the slow-start phase or the TCP CWND has dropped to a lower value which means that the DL connection of the UE has been already limited), the UE may be provided with more dense PUCCH-SR transmission occasions than normal case, so as to reduce the scheduling latency for TCP ACK. When the TCP CWND applied for the UE is sufficient high, the UE may have more continuous transmission in the DL, meaning that the UE is already able to trigger BSR more often such as padding BSR in the UL. In this case, it is unnecessary to trigger PUCCH-SR more often. Therefore, the UE may be provided with sparse PUCCH-SR transmission occasions to save radio resource.

FIG. 3 is a diagram illustrating an example of performance gain according to some embodiments of the present disclosure. The example shown in FIG. 3 clarifies the potential bit rate gain with the adaptive SR settings for DL TCP traffics. For the case of 3 cells and multiple 2 MB files per UE, as shown in FIG. 3, the FTP object bit rate decreases with increase of the number of users. For the UE in the slow-start phase, more frequent SR transmissions (e.g., with the SR period of 20 slots) can achieve significant DL object bit rate gain, compared with less frequent SR transmissions (e.g., with the SR period of 40 slots). It can be seen from FIG. 3 that with more frequent SR transmissions for UEs in the slow-start phase of TCP traffics, the DL throughput can be increased up to 25%.

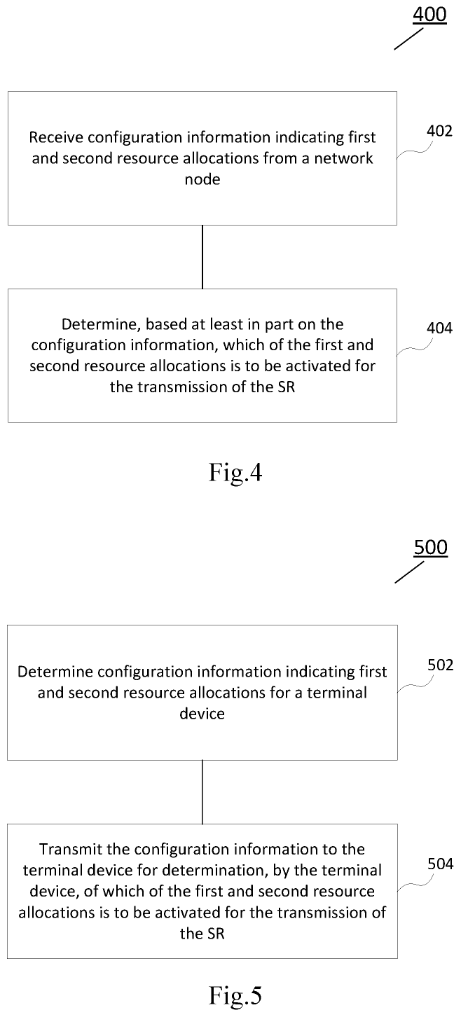

FIG. 4 is a flowchart illustrating a method 400 according to some embodiments of the present disclosure. The method 400 illustrated in FIG. 4 may be performed by a terminal device or an apparatus communicatively coupled to the terminal device. In accordance with an exemplary embodiment, the terminal device such as UE may be configured with radio resources adaptively by a network node such as a BS to schedule UL transmission.

According to the exemplary method 400 illustrated in FIG. 4, the terminal device may receive configuration information indicating first and second resource allocations from a network node, as shown in block 402. In accordance with some exemplary embodiments, the first resource allocation, compared with the second resource allocation, may assign more frequent occasions to the terminal device to transmit a SR for UL data. The configuration information may be included in RRC signaling, a MAC control element (CE) and/or downlink control information (DCI) for the terminal device.

Based at least in part on the configuration information, the terminal device can determine which of the first and second resource allocations is to be activated for the transmission of the SR, as shown in block 404. In accordance with some exemplary embodiments, the terminal device may determine to activate the first resource allocation during a first time period for which, compared with a second time period, more frequent occasions are needed by the terminal device to request scheduling of the UL data. Alternatively or additionally, the terminal device may determine to activate the second resource allocation during a second time period for which, compared with a first time period, less frequent occasions are needed by the terminal device to request scheduling of the UL data. Optionally, the first resource allocation may be inactivated when the second resource allocation is activated, and the second resource allocation may be inactivated when the first resource allocation is activated.

In accordance with some exemplary embodiments, the UL data of the terminal device may comprise data (e.g., TCP ACK) of a TCP service for the terminal device. Optionally, the terminal device during the first time period may be in a slow-start phase for the TCP service, and the terminal device during the second time period may be not in the slow-start phase. According to some exemplary embodiments, during the first time period, a DL connection between the terminal device and the network node may be configured with a first CWND below a first threshold, and during the second time period, the DL connection of the terminal device may be configured with a second CWND above a second threshold. Optionally, the second threshold may be the same as or different from the first threshold.

In accordance with some exemplary embodiments, the method 400 illustrated in FIG. 4 may be implemented as a switch method between two resource allocations for SR transmission. The configuration information indicating the first and second resource allocations may be associated with one SR configuration for the BE RB which carries TCP ACK in UL. Alternatively, the configuration information may be associated with two SR configurations mapped to the same BE RB.

In the implementation of one SR configuration, the terminal device such as a UE may be configured with the SR configuration comprising two SR resource patterns. The respective radio resources defined by the two SR resource patterns may be located on the same BWP or different BWPs. According to an exemplary embodiment, one of the two resource patterns can provide more frequent occasions for PUCCH-SR transmission, while the other can provide less frequent occasions for PUCCH-SR transmission. Thus, the SR intervals according to the two SR resource patterns are different.

In the implementation of two SR configurations, the UE may be configured with the SR configurations indicating different SR intervals. In this case, one of the two SR configurations can assign relative dense PUCCH-SR transmission occasions for the UE, and the other can assign relative sparse PUCCH-SR transmission occasions for the UE. For ease of illustration, the implementation of the two SR configurations may also be regarded as such embodiment that each of the SR configurations indicates one SR resource pattern.

In accordance with some exemplary embodiments, there may be only one SR resource pattern active at a time. The SR resource pattern with more often PUCCH-SR occasions may be active when the UE is in the slow-start phase of TCP traffics, while the other resource pattern may be active when the UE has passed the slow-start phase. According to an exemplary embodiment, the slow-start phase may be indicated by a predefined timer. For example, the predefined timer may be a specific timer introduced to the SR configuration. The start and stop operations of the timer may be related to the estimated time period for the TCP slow-start phase. When the timer is running, the UE can apply the SR resource pattern with more often PUCCH-SR occasions for TCP ACK transmission, while when the timer is expired, the UE can apply the SR resource pattern with less often PUCCH-SR occasions for TCP ACK transmission.

In accordance with some exemplary embodiments, the predefined timer used for indicating the slow-start phase may be set based at least in part on one or more performance parameters of the terminal device, such as radio condition, link quality, data rate of the terminal device, and etc. Optionally, the network node can reconfigure the setting of the timer when it is necessary. For example, the network node may be aware of that the UE may take a longer time period to do TCP slow-start. In this case, it is necessary to update the setting of the timer. Considering the longer TCP slow-start duration is needed for a higher data rate, the timer can be set to have an expiration time depending on one or more parameters which may impact the achievable data rate of the UE, such as carrier bandwidth, UE capability, the number of activated aggregated carriers, signal quality (e.g. reference signal received power (RSRP)) and service type, data rate restriction from backhaul, and etc. According to an exemplary embodiment, the timer may be started or restarted when the UE is assigned with a SR resource pattern providing dense SR occasions, while when the timer expires, the UE can use another SR resource pattern providing less dense SR occasions. In the case that the UE is indicated (e.g., by the network node or the UE itself) to use the SR resource pattern providing less dense SR occasions, the timer, if it is running, is stopped.

According to the exemplary method 400 illustrated in FIG. 4, the terminal device can optionally report to the network node at least one of: activation of one of the first and second resource allocations, and inactivation at least one of the first and second resource allocations. In this case, the terminal device can choose the first or the second resource allocation for SR transmission by itself, and send the report to the network node to indicate the selected SR resource allocation.

Alternatively or additionally, the activation/inactivation of the SR resource allocations can be controlled by the network. For example, the terminal device may receive an indicator from the network node to indicate the terminal device to activate one of the first and second resource allocations, and/or to inactivate at least one of the first and second resource allocations. The indicator may be carried in RRC signaling (e.g., system information or dedicated signaling) or a MAC CE, or a new DCI format. In accordance with some exemplary embodiments, in response to the reception of the indicator about the activation/inactivation of the first and second resource allocations, the terminal device may transmit a response to the indicator to the network node.

FIG. 5 is a flowchart illustrating another method 500 according to some embodiments of the present disclosure. The method 500 illustrated in FIG. 5 may be performed by a network node or an apparatus communicatively coupled to a network node. In accordance with an exemplary embodiment, the network node may comprise a BS such as eNB/gNB. The network node can configure radio resources for a terminal device such as UE to schedule UL transmission.

According to the exemplary method 500 illustrated in FIG. 5, the network node can determine configuration information indicating first and second resource allocations for a terminal device, as shown in block 502. In accordance with some exemplary embodiments, as described in connection with FIG. 4, the first resource allocation, compared with the second resource allocation, may assign more frequent occasions to the terminal device to transmit a SR for UL data. The network node can transmit the configuration information to the terminal device for determination, by the terminal device, of which of the first and second resource allocations is to be activated for the transmission of the SR, as shown in block 504. Optionally, the network node may include the configuration information in RRC signaling, a MAC CE and/or DCI, so as to inform the terminal device of radio resource, configuration options and/or other indication information.

In accordance with some exemplary embodiments, the network node can use an indicator to control activation/inactivation of the first and/or second resource allocations. The indicator may be determined by the network node according to at least one of: a radio condition of the terminal device; a traffic load of the network node; a DL data transmission situation of the terminal device; an inactivity period of the terminal device; a congestion control strategy applied to the terminal device; and a status of a predefined timer (e.g., a timer for indicating the TCP slow-start phase).

In accordance with some exemplary embodiments, the network node may indicate the terminal device to activate the first resource allocation during a first time period, and/or the second resource allocation during a second time period. Compared with the first time period, less frequent occasions are needed by the terminal device for the second time period to request scheduling of the UL data. Correspondingly, the terminal device may be assigned with dense SR occasions when a DL connection of the terminal device has lower send CWND (e.g., below the first threshold) during the first time period, and with less dense SR occasions when the DL connection has higher send CWND (e.g., above the second threshold) during the second time period. Optionally, the network node may receive from the terminal device a response to the indicator of the activation/inactivation of the first and/or second resource allocations. The terminal device may use the response (for example, in a MAC CE or a hybrid automatic repeat request (HARQ) feedback message) to inform the network node of the selection of the SR resource allocation by the terminal device.

Optionally, the terminal device may automatically determine to activate and/or inactivate which of the first and second resource allocations for the transmission of the SR, without receiving the indicator from the network node. In this case, the network node may receive a report of activation/inactivation of the first and/or second resource allocations from the terminal device. It can be appreciated that the timing of activating/inactivating of the first and/or second resource allocations may be predetermined and adjusted by the network node and/or the terminal device as required.

In the case that the UL data is related to a TCP service, the first time period may correspond to a slow-start phase for the TCP service, and the second time period may correspond to other phase different from the slow-start phase. According to some exemplary embodiments, the network node and/or the terminal device may use a predefined timer to indicate the start and end of the slow-start phase. Optionally, the status (such as on/off status) settings of the predefined timer may be configured and/or updated based at least in part on one or more performance parameters of the terminal device (e.g., achievable data rate, signal quality, device capability and etc.). According to status change of the predefined timer, the terminal device can switch between different SR resource allocations adaptively and flexibly.

In accordance with some exemplary embodiments, the determination of the configuration information by the network node may be based at least in part on a radio condition of the terminal device. Optionally, when the terminal device is in a good radio condition under which high data rate is achievable, for example, the RSRP of the terminal device is higher than a threshold, the network node can determine that the configuration information allows the terminal device to be configured with dense SR occasions (e.g., for the slow-start phase) and less dense SR occasions (e.g., for other phase different from the slow-start phase). In the case that the terminal device is not in a good radio condition, the configuration information determined by the network node may enable the terminal device to be configured only with less dense SR occasions, regardless of the terminal device being in the slow-start phase or not.

The proposed solution according to one or more exemplary embodiments can enable a network node such as BS to configure adaptive resource allocations for SR transmission of a terminal device such as UE, so that the UE can switch between different SR resource allocations flexibly according to traffic characteristics. In the proposed solution, the UE can be configured with more often SR occasions in the slow-start phase of TCP traffics, and/or less often SR occasions in other phase of TCP traffics. Taking advantageous of the proposed scheduling solution can improve the DL and UL throughput and the latency performance of the UE by reducing object delay. On the other hand, the utilization of radio resources can be enhanced due to that the BS can provide SR transmission occasions with different density to the UE as required.

The various blocks shown in FIGS. 4-5 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

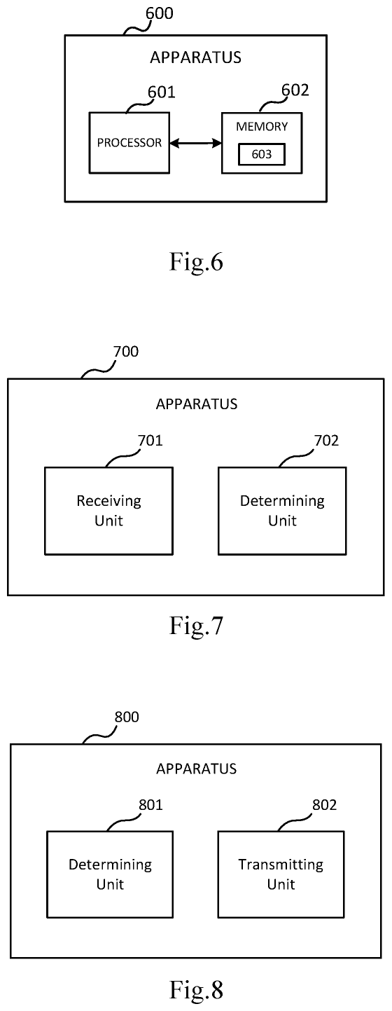

FIG. 6 is a block diagram illustrating an apparatus 600 according to various embodiments of the present disclosure. As shown in FIG. 6, the apparatus 600 may comprise one or more processors such as processor 601 and one or more memories such as memory 602 storing computer program codes 603. The memory 602 may be non-transitory machine/processor/computer readable storage medium. In accordance with some exemplary embodiments, the apparatus 600 may be implemented as an integrated circuit chip or module that can be plugged or installed into a terminal device as described with respect to FIG. 4, or a network node as described with respect to FIG. 5. In such case, the apparatus 600 may be implemented as a terminal device as described with respect to FIG. 4, or a network node as described with respect to FIG. 5.

In some implementations, the one or more memories 602 and the computer program codes 603 may be configured to, with the one or more processors 601, cause the apparatus 600 at least to perform any operation of the method as described in connection with FIG. 4. In other implementations, the one or more memories 602 and the computer program codes 603 may be configured to, with the one or more processors 601, cause the apparatus 600 at least to perform any operation of the method as described in connection with FIG. 5.

Alternatively or additionally, the one or more memories 602 and the computer program codes 603 may be configured to, with the one or more processors 601, cause the apparatus 600 at least to perform more or less operations to implement the proposed methods according to the exemplary embodiments of the present disclosure.

FIG. 7 is a block diagram illustrating an apparatus 700 according to some embodiments of the present disclosure. The apparatus 700 may be implemented as a terminal device or as a part of the terminal device. As shown in FIG. 7, the apparatus 700 may comprise a receiving unit 701 and a determining unit 702. In an exemplary embodiment, the apparatus 700 may be implemented in a terminal device such as UE. The receiving unit 701 may be operable to carry out the operation in block 402, and the determining unit 702 may be operable to carry out the operation in block 404. Optionally, the receiving unit 701 and/or determining unit 702 may be operable to carry out more or less operations to implement the proposed methods according to the exemplary embodiments of the present disclosure.

FIG. 8 is a block diagram illustrating an apparatus 800 according to some embodiments of the present disclosure. The apparatus 800 may be implemented as a network node or as a part of the network node. As shown in FIG. 8, the apparatus 800 may comprise a determining unit 801 and a transmitting unit 802. In an exemplary embodiment, the apparatus 800 may be implemented in a network node such as BS. The determining unit 801 may be operable to carry out the operation in block 502, and the transmitting unit 802 may be operable to carry out the operation in block 504. Optionally, the determining unit 801 and/or the transmitting unit 802 may be operable to carry out more or less operations to implement the proposed methods according to the exemplary embodiments of the present disclosure.

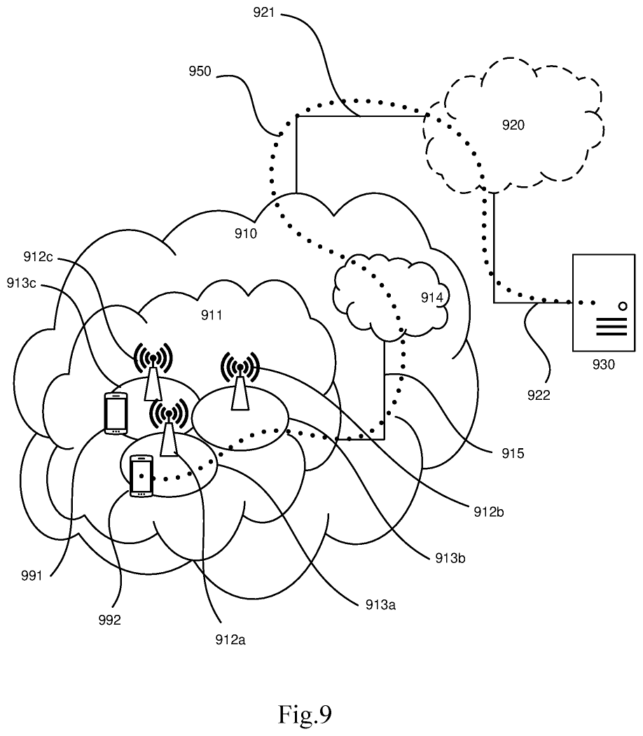

FIG. 9 is a block diagram illustrating a telecommunication network connected via an intermediate network to a host computer in accordance with some embodiments of the present disclosure.

With reference to FIG. 9, in accordance with an embodiment, a communication system includes a telecommunication network 910, such as a 3GPP-type cellular network, which comprises an access network 911, such as a radio access network, and a core network 914. The access network 911 comprises a plurality of base stations 912a, 912b, 912c, such as NBs, eNBs, gNBs or other types of wireless access points, each defining a corresponding coverage area 913a, 913b, 913c. Each base station 912a, 912b, 912c is connectable to the core network 914 over a wired or wireless connection 915. A first UE 991 located in a coverage area 913c is configured to wirelessly connect to, or be paged by, the corresponding base station 912c. A second UE 992 in a coverage area 913a is wirelessly connectable to the corresponding base station 912a. While a plurality of UEs 991, 992 are illustrated in this example, the disclosed embodiments are equally applicable to a situation where a sole UE is in the coverage area or where a sole UE is connecting to the corresponding base station 912.

The telecommunication network 910 is itself connected to a host computer 930, which may be embodied in the hardware and/or software of a standalone server, a cloud-implemented server, a distributed server or as processing resources in a server farm. The host computer 930 may be under the ownership or control of a service provider, or may be operated by the service provider or on behalf of the service provider. Connections 921 and 922 between the telecommunication network 910 and the host computer 930 may extend directly from the core network 914 to the host computer 930 or may go via an optional intermediate network 920. An intermediate network 920 may be one of, or a combination of more than one of, a public, private or hosted network; the intermediate network 920, if any, may be a backbone network or the Internet; in particular, the intermediate network 920 may comprise two or more sub-networks (not shown).

The communication system of FIG. 9 as a whole enables connectivity between the connected UEs 991, 992 and the host computer 930. The connectivity may be described as an over-the-top (OTT) connection 950. The host computer 930 and the connected UEs 991, 992 are configured to communicate data and/or signaling via the OTT connection 950, using the access network 911, the core network 914, any intermediate network 920 and possible further infrastructure (not shown) as intermediaries. The OTT connection 950 may be transparent in the sense that the participating communication devices through which the OTT connection 950 passes are unaware of routing of uplink and downlink communications. For example, the base station 912 may not or need not be informed about the past routing of an incoming downlink communication with data originating from the host computer 930 to be forwarded (e.g., handed over) to a connected UE 991. Similarly, the base station 912 need not be aware of the future routing of an outgoing uplink communication originating from the UE 991 towards the host computer 930.

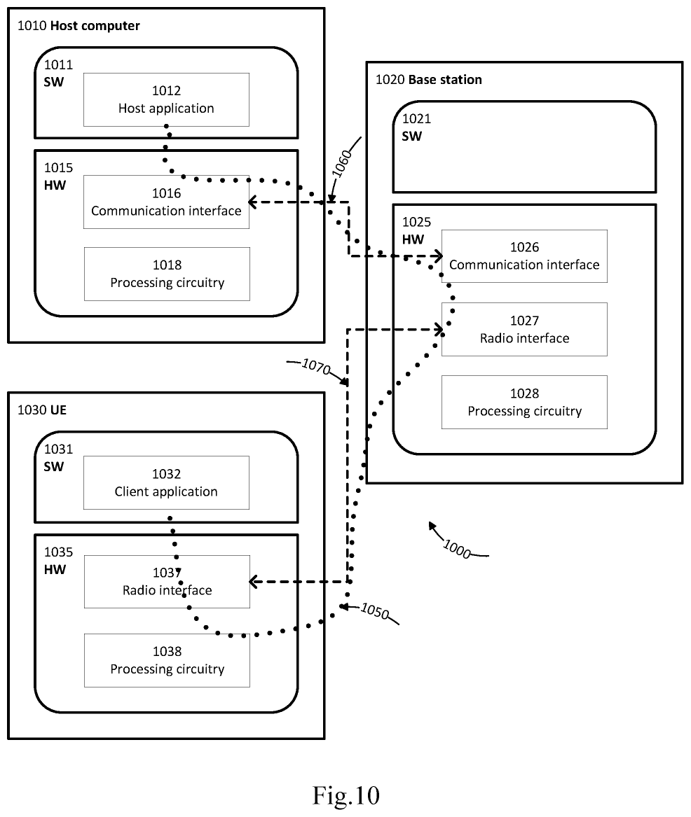

FIG. 10 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 10. In a communication system 1000, a host computer 1010 comprises hardware 1015 including a communication interface 1016 configured to set up and maintain a wired or wireless connection with an interface of a different communication device of the communication system 1000. The host computer 1010 further comprises a processing circuitry 1018, which may have storage and/or processing capabilities. In particular, the processing circuitry 1018 may comprise one or more programmable processors, application-specific integrated circuits, field programmable gate arrays or combinations of these (not shown) adapted to execute instructions. The host computer 1010 further comprises software 1011, which is stored in or accessible by the host computer 1010 and executable by the processing circuitry 1018. The software 1011 includes a host application 1012. The host application 1012 may be operable to provide a service to a remote user, such as UE 1030 connecting via an OTT connection 1050 terminating at the UE 1030 and the host computer 1010. In providing the service to the remote user, the host application 1012 may provide user data which is transmitted using the OTT connection 1050.

The communication system 1000 further includes a base station 1020 provided in a telecommunication system and comprising hardware 1025 enabling it to communicate with the host computer 1010 and with the UE 1030. The hardware 1025 may include a communication interface 1026 for setting up and maintaining a wired or wireless connection with an interface of a different communication device of the communication system 1000, as well as a radio interface 1027 for setting up and maintaining at least a wireless connection 1070 with the UE 1030 located in a coverage area (not shown in FIG. 10) served by the base station 1020. The communication interface 1026 may be configured to facilitate a connection 1060 to the host computer 1010. The connection 1060 may be direct or it may pass through a core network (not shown in FIG. 10) of the telecommunication system and/or through one or more intermediate networks outside the telecommunication system. In the embodiment shown, the hardware 1025 of the base station 1020 further includes a processing circuitry 1028, which may comprise one or more programmable processors, application-specific integrated circuits, field programmable gate arrays or combinations of these (not shown) adapted to execute instructions. The base station 1020 further has software 1021 stored internally or accessible via an external connection.

The communication system 1000 further includes the UE 1030 already referred to. Its hardware 1035 may include a radio interface 1037 configured to set up and maintain a wireless connection 1070 with a base station serving a coverage area in which the UE 1030 is currently located. The hardware 1035 of the UE 1030 further includes a processing circuitry 1038, which may comprise one or more programmable processors, application-specific integrated circuits, field programmable gate arrays or combinations of these (not shown) adapted to execute instructions. The UE 1030 further comprises software 1031, which is stored in or accessible by the UE 1030 and executable by the processing circuitry 1038. The software 1031 includes a client application 1032. The client application 1032 may be operable to provide a service to a human or non-human user via the UE 1030, with the support of the host computer 1010. In the host computer 1010, an executing host application 1012 may communicate with the executing client application 1032 via the OTT connection 1050 terminating at the UE 1030 and the host computer 1010. In providing the service to the user, the client application 1032 may receive request data from the host application 1012 and provide user data in response to the request data. The OTT connection 1050 may transfer both the request data and the user data. The client application 1032 may interact with the user to generate the user data that it provides.

It is noted that the host computer 1010, the base station 1020 and the UE 1030 illustrated in FIG. 10 may be similar or identical to the host computer 930, one of base stations 912a, 912b, 912c and one of UEs 991, 992 of FIG. 9, respectively. This is to say, the inner workings of these entities may be as shown in FIG. 10 and independently, the surrounding network topology may be that of FIG. 9.

In FIG. 10, the OTT connection 1050 has been drawn abstractly to illustrate the communication between the host computer 1010 and the UE 1030 via the base station 1020, without explicit reference to any intermediary devices and the precise routing of messages via these devices. Network infrastructure may determine the routing, which it may be configured to hide from the UE 1030 or from the service provider operating the host computer 1010, or both. While the OTT connection 1050 is active, the network infrastructure may further take decisions by which it dynamically changes the routing (e.g., on the basis of load balancing consideration or reconfiguration of the network).

Wireless connection 1070 between the UE 1030 and the base station 1020 is in accordance with the teachings of the embodiments described throughout this disclosure. One or more of the various embodiments improve the performance of OTT services provided to the UE 1030 using the OTT connection 1050, in which the wireless connection 1070 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 1050 between the host computer 1010 and the UE 1030, in response to variations in the measurement results. The measurement procedure and/or the network functionality for reconfiguring the OTT connection 1050 may be implemented in software 1011 and hardware 1015 of the host computer 1010 or in software 1031 and hardware 1035 of the UE 1030, or both. In embodiments, sensors (not shown) may be deployed in or in association with communication devices through which the OTT connection 1050 passes; the sensors may participate in the measurement procedure by supplying values of the monitored quantities exemplified above, or supplying values of other physical quantities from which the software 1011, 1031 may compute or estimate the monitored quantities. The reconfiguring of the OTT connection 1050 may include message format, retransmission settings, preferred routing etc.; the reconfiguring need not affect the base station 1020, and it may be unknown or imperceptible to the base station 1020. Such procedures and functionalities may be known and practiced in the art. In certain embodiments, measurements may involve proprietary UE signaling facilitating the host computer 1010's measurements of throughput, propagation times, latency and the like. The measurements may be implemented in that the software 1011 and 1031 causes messages to be transmitted, in particular empty or ‘dummy’ messages, using the OTT connection 1050 while it monitors propagation times, errors etc.

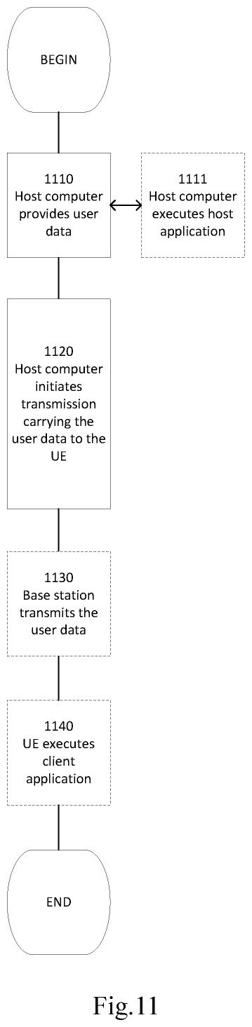

FIG. 11 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 11 will be included in this section. In step 1110, the host computer provides user data. In substep 1111 (which may be optional) of step 1110, the host computer provides the user data by executing a host application. In step 1120, the host computer initiates a transmission carrying the user data to the UE. In step 1130 (which may be optional), the base station transmits to the UE the user data which was carried in the transmission that the host computer initiated, in accordance with the teachings of the embodiments described throughout this disclosure. In step 1140 (which may also be optional), the UE executes a client application associated with the host application executed by the host computer.

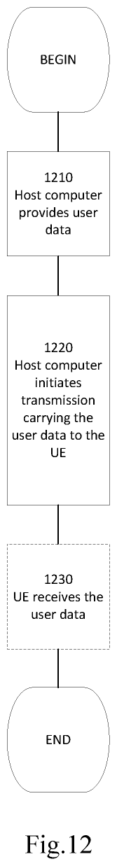

FIG. 12 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 12 will be included in this section. In step 1210 of the method, the host computer provides user data. In an optional substep (not shown) the host computer provides the user data by executing a host application. In step 1220, the host computer initiates a transmission carrying the user data to the UE. The transmission may pass via the base station, in accordance with the teachings of the embodiments described throughout this disclosure. In step 1230 (which may be optional), the UE receives the user data carried in the transmission.

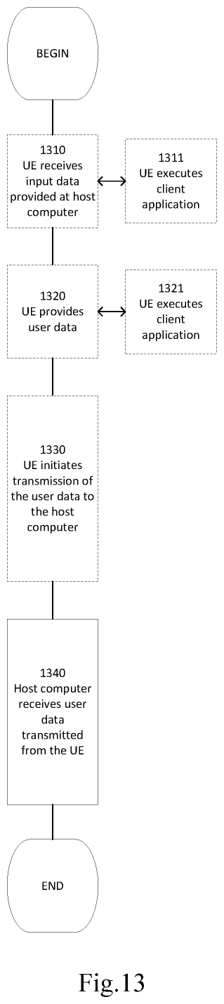

FIG. 13 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 13 will be included in this section. In step 1310 (which may be optional), the UE receives input data provided by the host computer. Additionally or alternatively, in step 1320, the UE provides user data. In substep 1321 (which may be optional) of step 1320, the UE provides the user data by executing a client application. In substep 1311 (which may be optional) of step 1310, the UE executes a client application which provides the user data in reaction to the received input data provided by the host computer. In providing the user data, the executed client application may further consider user input received from the user. Regardless of the specific manner in which the user data was provided, the UE initiates, in substep 1330 (which may be optional), transmission of the user data to the host computer. In step 1340 of the method, the host computer receives the user data transmitted from the UE, in accordance with the teachings of the embodiments described throughout this disclosure.

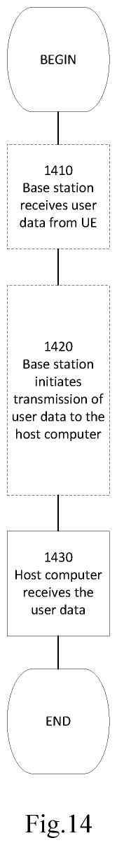

FIG. 14 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 14 will be included in this section. In step 1410 (which may be optional), in accordance with the teachings of the embodiments described throughout this disclosure, the base station receives user data from the UE. In step 1420 (which may be optional), the base station initiates transmission of the received user data to the host computer. In step 1430 (which may be optional), the host computer receives the user data carried in the transmission initiated by the base station.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a terminal device, comprising:
receiving configuration information indicating first and second resource allocations from a network node; and
determining, based at least in part on the configuration information, which of the first and second resource allocations is to be activated for transmission of a scheduling request for uplink data.

2. The method according to claim 1, wherein the first resource allocation, compared with the second resource allocation, assigns more frequent occasions to the terminal device to transmit the scheduling request.

3. The method according to claim 1, wherein the determination of which of the first and second resource allocations is to be activated for the transmission of the scheduling request based at least in part on the configuration information comprises:
determining to activate the first resource allocation during a first time period for which, compared with a second time period, more frequent occasions are needed by the terminal device to request scheduling of the uplink data.

4. The method according to claim 1, wherein the determination of which of the first and second resource allocations is to be activated for the transmission of the scheduling request based at least in part on the configuration information comprises:
determining to activate the second resource allocation during a second time period for which, compared with a first time period, less frequent occasions are needed by the terminal device to request scheduling of the uplink data.

5. The method according to claim 3, wherein the first resource allocation is inactivated when the second resource allocation is activated, and the second resource allocation is inactivated when the first resource allocation is activated.

6. The method according to claim 3, wherein the uplink data comprise data of a transmission control protocol service.

7. The method according to claim 6, wherein the terminal device during the first time period is in a slow-start phase for the transmission control protocol service, and the terminal device during the second time period is not in the slow-start phase.

8. The method according to claim 7, wherein the slow-start phase is indicated by a predefined timer.

9. The method according to claim 8, wherein the predefined timer is set based at least in part on one or more performance parameters of the terminal device.

10. The method according to claim 3, wherein during the first time period, a downlink connection between the terminal device and the network node is configured with a first congestion window below a first threshold, and wherein during the second time period, the downlink connection of the terminal device is configured with a second congestion window above a second threshold.

11. The method according to claim 1, further comprising receiving an indicator from the network node to indicate the terminal device to perform at least one of:
activating one of the first and second resource allocations; and
inactivating at least one of the first and second resource allocations.

12. The method according to claim 11, further comprising:
transmitting a response to the indicator to the network node, in response to the reception of the indicator.

13. The method according to claim 1, further comprising reporting to the network node at least one of:
activation of one of the first and second resource allocations; and
inactivation at least one of the first and second resource allocations.

14. A method performed by a network node, comprising:
determining configuration information indicating first and second resource allocations for a terminal device; and
transmitting the configuration information to the terminal device for determination, by the terminal device, of which of the first and second resource allocations is to be activated for transmission of a scheduling request for uplink data.

15. (canceled)

16. The method according to claim 14, wherein the first resource allocation is activated during a first time period for which, compared with a second time period, more frequent occasions are needed by the terminal device to request scheduling of the uplink data.

17. The method according to claim 14, wherein the second resource allocation is activated during a second time period for which, compared with a first time period, less frequent occasions are needed by the terminal device to request scheduling of the uplink data.

18-23. (canceled)

24. The method according to claim 14, further comprising transmitting an indicator to the terminal device to indicate the terminal device to perform at least one of:
activating one of the first and second resource allocations; and
inactivating at least one of the first and second resource allocations.

25. The method according to claim 24, wherein the indicator is determined by the network node according to at least one of:
a radio condition of the terminal device;
a traffic load of the network node;
a downlink data transmission situation of the terminal device;
an inactivity period of the terminal device;
a congestion control strategy applied to the terminal device; and
a status of a predefined timer.

26. (canceled)

27. (canceled)

28. The method according to claim 14, wherein the determination of the configuration information is based at least in part on a radio condition of the terminal device.

29. A terminal device, comprising:
one or more processors; and
one or more memories comprising computer program codes,
the one or more memories and the computer program codes configured to, with the one or more processors, cause the terminal device at least to:
receive configuration information indicating first and second resource allocations from a network node; and
determine, based at least in part on the configuration information, which of the first and second resource allocations is to be activated for transmission of a scheduling request for uplink data.

30. (canceled)
